(19) United States
(12) Patent Application Publication
(10) Pub. No.: US 2013/0282348 A1
(43) Pub. Date: Oct. 24, 2013

(54) EFFICIENT DATA MAPPING TECHNIQUE FOR SIMULATION COUPLING USING LEAST SQUARES FINITE ELEMENT METHOD

(71) Applicant: Yongnuan Liu, Calgary (CA)

(72) Inventor: Yongnuan Liu, Calgary (CA)

(73) Assignee: CONOCOPHILLIPS COMPANY, Houston, TX (US)

(21) Appl. No.: 13/856,690

(22) Filed: Apr. 4, 2013

Related U.S. Application Data
(60) Provisional application No. 61/637,638, filed on Apr. 24, 2012.

(51) Int. Cl. G06F 17/50

(52) U.S. Cl. CPC G06F 17/5018
USPC 703/10

(57) ABSTRACT

The coupling of geomechanics to reservoir simulation is essential for many practical situations in the exploitation of hydrocarbons. Such coupling requires cross-mapping block-centered data in reservoir model to nodal data in geomechanical finite element model. If different grid geometries and grid densities between two models are used, this data mapping will become considerably challenging. In this invention, an innovative method is proposed to achieve remarkable accuracy of data mapping from reservoir model to the geomechanical model with ease and quite efficiently using least squares finite element method. The achievement of accurate data mapping will enable efficient simulation coupling between reservoir simulation and geomechanical simulation to investigate some engineering problems in the exploitation of hydrocarbons.

### CROSS-REFERENCE TO RELATED APPLICATIONS

This application is a non-provisional application which claims benefit under 35 USC §119(e) to U.S. Provisional Application Ser. No. 61/637,638 filed Apr. 24, 2012, entitled “AN EFFICIENT DATA MAPPING TECHNIQUE FOR SIMULATION COUPLING USING LEAST SQUARES FINITE ELEMENT METHOD,” which is incorporated herein in its entirety.

### STATEMENT REGARDING FEDERALLY SPONSORED RESEARCH OR DEVELOPMENT

None.

### FIELD OF THE INVENTION

This invention relates to simulation data of reservoir flows and geomechanical simulation of reservoirs for the exploitation of hydrocarbon reservoirs.

### BACKGROUND OF THE INVENTION

The coupling of geomechanics to reservoir simulation is essential for many practical situations in the exploitation of hydrocarbons, for example, in evaluating the impact of reservoir compaction to improvement of production potential and adverse environmental effects of subsequent subsidence and in investigating the caprock integrity in Cyclic Steam Stimulation (CSS) and Steam Assisted Gravity Drainage (SAGD) thermal recovery processes etc. However, the simulation coupling requires mapping block-centered data in reservoir simulation model to nodal data in geomechanical finite element model and vice versa. There are circumstances where different grid geometries have to be used between two simulation models. For example, the hexahedral type of grid is typically used in reservoir simulation model no matter whether faults and fractures exist. However, the existence of faults and fractures will necessitate the employment of a different grid geometry, such as tetrahedral elements, in the geomechanical simulation model. And a higher grid density is also generally necessary in a geomechanical simulation than in a reservoir simulation in order to gain the accuracy of geomechanical simulation results. Under these circumstances where grid geometry and grid density are different between two models, data mapping becomes very challenging.

### BRIEF SUMMARY OF THE DISCLOSURE

The invention more particularly relates to a process for the data mapping from block centered reservoir simulation model to node centered finite element model in geomechanical simulation wherein each numerical integration point of each finite element used in geomechanical model is identified and located and find the reservoir grid block where the point falls inside. The data values are equalized at numerical integration points of geomechanical simulation elements to the block-center data value of their associated reservoir grid blocks found at that previous step. Finally a least squares finite element method for data mapping is performed.

### BRIEF DESCRIPTION OF THE DRAWINGS

A more complete understanding of the present invention and benefits thereof may be acquired by referring to the follow description taken in conjunction with the accompanying drawings in which:

FIG. 1 is a schematic drawing showing different grid geometries overlaid in the same area between reservoir model (dash line) and geomechanical finite element mode (solid line);

FIG. 2A is a schematic drawing showing the finite element integration points of a triangle element;

FIG. 2B is a schematic drawing showing the finite element integration points of a tetrahedral element;

FIG. 3 is a schematic drawing showing an example of locating reservoir grid block for each numerical integration point of a triangle element;

FIG. 4 is a schematic drawings showing an example of inferring pressure value of each integration point;

FIG. 5 is a perspective view of a block centered reservoir model of an example reservoir in reservoir flow simulation;

FIG. 6 is a close-up perspective view of the block centered reservoir model in reservoir flow simulation shown in FIG. 5;

FIG. 7 is a perspective view of the same reservoir from FIG. 5, but is a geomechanical simulation model having a random and irregular grid pattern;

FIG. 8 is a close-up perspective view of geomechanical simulation model shown in FIG. 7 better showing the more irregular shapes of the elements;

FIG. 9 is a two dimensional chart showing the pressure distribution of the reservoir modeled in FIGS. 5 through 6 at a common depth;

FIG. 10 is a chart showing the mapped pressure distribution of the reservoir in the geomechanical simulation model at the same depth as shown in FIG. 9, where the calculations are based on the inventive technique;

FIG. 11 is a chart showing the pressure distribution of the reservoir modeled in FIGS. 5 through 6 at a common depth about 100 feet above the depth selected for FIGS. 9 and 10;

FIG. 12 is a chart showing the mapped pressure distribution of the reservoir in the geomechanical simulation model at the same depth as shown in FIG. 11, where the calculations are based on the inventive technique;

FIG. 13 is a chart showing the pressure distribution of the reservoir modeled in FIGS. 5 through 6 at a common depth about 80 feet above the depth selected for FIGS. 11 and 12; and

FIG. 14 is a chart showing the mapped pressure distribution of the reservoir in the geomechanical simulation model at the same depth as shown in FIG. 13, where the calculations are based on the inventive technique.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

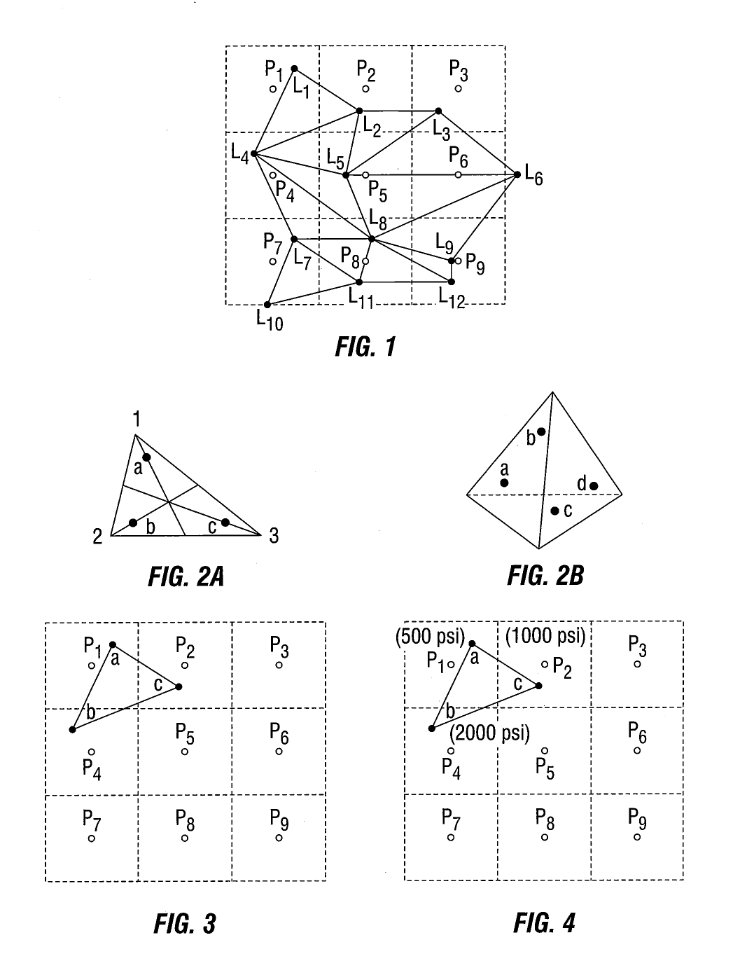

FIG. 1 shows the basic schematics of the two different grid geometries used in reservoir simulation and geomechanical finite element simulation over a same section. The data in reservoir grid are represented by block-centered values of 9 blocks in dashed lines labeled P₁ through P₉. The blocks P1 through P9 in the model are determined to have a value that is, for simplicity, interpreted as uniform across each block. Overlying the 9 blocks are 12 nodal values labeled L₁ through L₁₂ with subscript denoting the node number. The nodes present finite element geomechanical simulation data. In order to couple the reservoir flow simulation to the geomechanical simulation to investigate the mechanical deformation of reservoir and its impact on flow behavior of the hydrocarbons, mapping {P₁, P₂, . . . P₉} to {L₁, L₂, . . . L₁₂} is a prerequisite and is crucial. However, this mapping is also technically challenging since the node distribution in the geomechanical model is considerably random and irregular with respective to the geometry of block centers of the reservoir model.

The present invention comprises a least squares finite element method along with a procedure to achieve accuracy and efficiency of this complex data mapping with ease.

The data mapping procedure of the present invention consists of two major steps: the first is point-block geometry mapping and the second is the application of least squares finite element analysis method. The procedure described below gives an example of a 2D problem with a triangle element in geomechanical model. Without loss of generality, the procedure can also be applied to quadrilateral elements in 2D and tetrahedral elements or hexahedral elements in 3D problem. The first step is to identify and locate the numerical integration points of each finite element. As shown in FIG. 2A, the integration points a, b and c of a triangular element are shown. In FIG. 2B, the integration points a, b, c and d of a tetrahedral element are shown.

The next step is to identify which block each of these numerical integration points is located. In FIG. 3, the grid blocks are shown in dashed lines and the numerical integration points a, b and c are found in blocks P₁, P₄ and P₂, respectively.

The next step is to equalize data value at numerical integration points to the block-center data value of their associated reservoir grid blocks found at previous step. Reservoir data is grid-centered based, which means that all the points inside a grid block will have the same value of data, which is equal to value at the center. Therefore, if a numerical integration point of finite elements is inside one reservoir grid block, it has the exactly same value of data as that reservoir grid block. For example, in FIG. 4, the grid blocks number P₁, P₂, P₄ have pressure value of 500 psi, 1000 psi and 2000 psi, respectively. Known from FIG. 3, numerical integration points a, b, c are inside reservoir block numbers of P₁, P₄, P₂ respectively. As a result, pressure values at these points are equal to 500 psi, 2000 psi and 1000 psi, respectively.

The next step is to perform a least squares finite element computation. Setting up the computation, let us define p₀(x,y) as the pressure function inferring from known value of each numerical integration point within each finite element, and also define p(x,y) as the other pressure function inferring from data value at each finite element node which we are seeking for. Thus, there are two pressure distribution functions, p₀(x,y) and p(x,y), defined over the same finite element model domain (x,y). The goal is to find the integral minimal differences between p(x,y) and p₀(x,y) over any location within (x,y). This problem can be solved using least squares finite element method as described below. Firstly, we define a least squares functional F(p) over the model domain V=V(x,y), i.e.

$$F ( p ) = {\int }_{V}^{ } {[ p ( x , y ) - {p}_{0} ( x , y ) ]}^{2} d V \qquad ( 1 )$$

By virtue of variational principle, finding the minimal of functional F(p) can be achieved by performing δF(p)=0. So we can have

$${\int }_{V}^{ } p δ p d V = {\int }_{V}^{ } {p}_{0} δ p d V \qquad ( 2 )$$

where δp refers to the virtual increment of the data function p(x,y).

Then, equation (2) can be discretized using a Galerkin finite element technique to easily solve for nodal solutions of finite elements in the following matrix forms,

$$\{ \begin{matrix}{K}_{11} & {K}_{12} & … & {K}_{1 n} \\ {K}_{21} & {K}_{22} & & \\ … & & … & \\ {K}_{n 1} & & & {K}_{n}\end{matrix} \} \{ \begin{matrix}{p}^{1} \\ {p}^{2} \\ … \\ {p}^{n}\end{matrix} \} = \{ \begin{matrix}{f}_{1} \\ {f}_{2} \\ … \\ {f}_{n}\end{matrix} \} \qquad ( 3 )$$

where p={p¹ p². . . pⁿ} referring to the nodal solution of finite elements, n is the total number of nodes in each element, and

$$\begin{matrix}{f}_{k} = {\sum }_{i = 1}^{{n}_{gp}} {W}_{i} \vert {J}^{e} ( {ξ}_{i} ) \vert {p}_{0} ( {ξ}_{i} ) {N}_{k} ( {ξ}_{i} ) , \\ k = 1 , 2 , … n \\ and & ( 4 ) \\ {K}_{kl} = {\sum }_{i = 1}^{{n}_{gp}} {W}_{i} \vert {J}^{e} ( {ξ}_{i} ) \vert {N}_{l} ( {ξ}_{i} ) {N}_{k} ( {ξ}_{i} ) , \\ ( k or l ) = 1 , 2 , … n & ( 5 )\end{matrix}$$

where ξᵢ is the triangular coordinate of a triangle element at point i shown in FIG. 2, which is also called the area coordinate, Wᵢ are Gauss quadrature weight for each numerical integration point i, n_{gp} is the number of Gauss quadrature points, |J|^{e} is the determinant of the Jacobian matrix which relates the area in local coordinates to that in global coordinates for element e and Nₖ is the shape function at node k, which will be explained later.

As such, p₀(ξᵢ) is the estimated solution of p₀(x,y) at numerical integration point i of a triangle element. As shown in FIG. 4 at step 2,

p₀(ξᵢ)=p₁ (6)

where p₁ is the block center value of block 1 in the reservoir model, in which integration point ξᵢ is inside.

So Equation (4) can also be written as

$${f}_{k} = {\sum }_{i = 1}^{{n}_{gp}} {W}_{i} \vert {J}^{e} ( {ξ}_{i} ) \vert {p}_{l} {N}_{k} ( {ξ}_{i} ) , \\ k = 1 , 2 , … n \qquad ( 7 )$$

Once we obtain p={p¹ p². . . pⁿ} after solving Equation (3), we will finish mapping the reservoir block center-based solutions of {p₁ p₂. . . pₘ} to finite element nodal solutions of {p¹ p². . . pⁿ} as shown in FIG. 1.

The above method can be compared to other methods described as follows:

Equation 3 can be interpreted as solving for p₁ in the reservoir model (the right hand side term in Equation 3) by means of averaging nodal values p={p¹ p². . . pⁿ} in a geomechanical model with Kₖ₁ being the averaging coefficients. As known from Equation (5), averaging coefficients Kₖ₁ are functions of a shape function for a triangle element. Hence, this averaging can be called shape function based weighted averaging.

Shape function Nₖ in Equations 4 and 5 in a 2D triangle element is defined as equal to its area coordinate (triangular coordinate) or volume coordinate in 3D tetrahedral element. For example,

Ni=ξᵢ in 2D triangle element (8)

where

$$[ \begin{matrix}{ξ}_{1} \\ {ξ}_{2} \\ {ξ}_{3}\end{matrix} ] = \frac{1}{2 {A}^{e}} [ \begin{matrix}{x}_{1} {y}_{3} - {x}_{3} {y}_{2} & {y}_{23} & {x}_{32} \\ {x}_{3} {y}_{1} - {x}_{1} {y}_{3} & {y}_{31} & {x}_{13} \\ {x}_{1} {y}_{2} - {x}_{2} {y}_{1} & {y}_{12} & {x}_{21}\end{matrix} ] [ \begin{matrix}1 \\ x \\ y\end{matrix} ] \qquad ( 9 )$$

where (xᵢ,yᵢ) denoting the global (x,y) coordinates of node i shown in FIGS. 2A and 2B and x_{IJ}=x_{I}−x_{J}, y_{IJ}=y_{I}−y_{J}.

Continuing with the explanation, it is known from Equations (8) and (9), this shape function weighted averaging can account for the geometrical relationship between data points of two different grid models and is very similar to distance weighted averaging method widely used by previous researchers in data mapping. However, the shape function weighted averaging method according the present invention is different and offers many advantages over other distance weighted averaging methods.

A first advantage is that a distance weighted averaging method requires searching for all neighboring reservoir blocks for each node. The number of neighboring reservoir blocks for each node is likely to be at least 8 in 2D considerations as shown in FIG. 1, and will be as high as 25 or more in 3D considerations. A huge number of nodes and grid blocks in field scale reservoir simulation, along with irregular geometry and a random distribution of those nodes and block-centers will definitely make those approaches considerably tedious and prone to poor accuracy. In contrast, the proposed method in this invention only needs to locate only one reservoir block for each node as shown in step 1 of the procedure. So, by comparison, the inventive method is simple and efficient.

A second advantage is that distance weighted averaging requires calculation of all the distances between each node and block center of all of its neighboring blocks as weight coefficients. This is time consuming and not efficient. In contrast, the averaging weight coefficient in proposed method is based on a shape function which is a basic concept in finite element simulation, which automatically accounts for geometric relationship between different data points. Thus, there is no need to calculate the distances. And the averaging can be linear or quadratic, depending on which type of elements used in geomechanical model. As a result, this is believed to be more accurate.

In addition, the proposed method will also employ the classical least squares curve fitting method to fit reservoir model data to geomechanical model data. This should improve the accuracy of data mapping.

In summary, the proposed method in this invention has advantages of simplicity, efficiency and accuracy over other methods, such as distance weighted averaging method widely used by previous researchers.

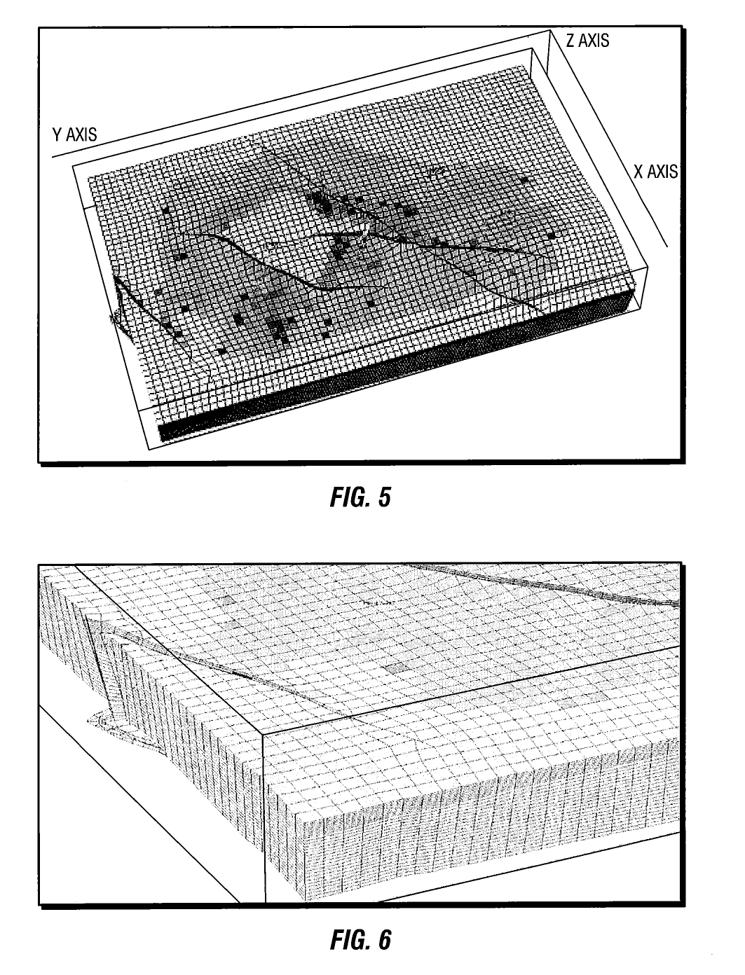

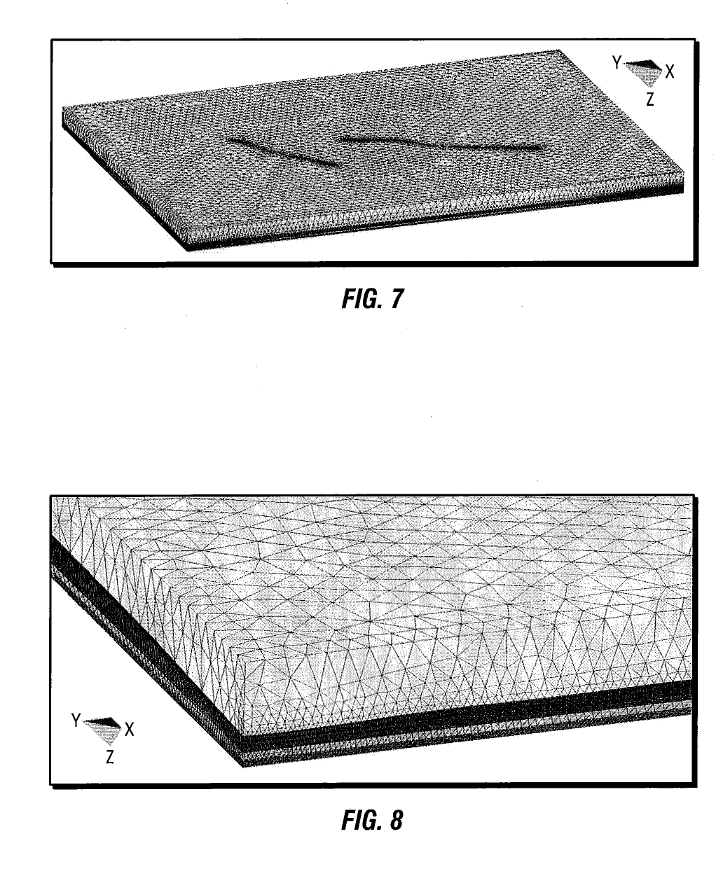

FIG. 5 shows the grid geometry of a reservoir model in reservoir flow simulation with a close-up of the grid geometry at left bottom corner shown in FIG. 6. A hexahedral type of grid was used in this reservoir model of FIG. 6 which is a quite regular geometry. In comparison, FIG. 7 shows that a different grid (tetrahedral type) that was employed in a geomechanical model, where random and irregular distribution of nodes can be clearly observed in the close-up view as shown in FIG. 8. As mentioned before, the objective is to map block-centered pressure data in FIGS. 5 and 6 to nodal pressure data in FIGS. 7 and 8 and map them accurately. The distinction in two geometries will make data mapping between two models extremely complicated.

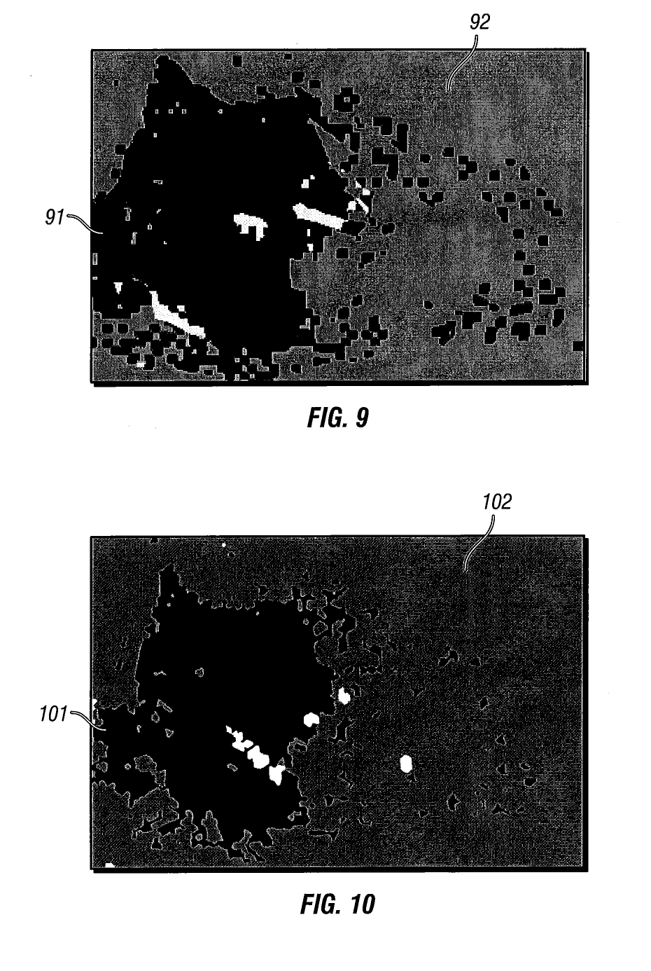

FIG. 9 shows the pressure distribution at a specific depth in the example reservoir in the reservoir model where high pressure areas are in the darker gray area 91, lower pressure is in the lower gray area 92. The mapped pressure distribution in the geomechanical model using the inventive method is presented in FIG. 10 also shows higher pressure 101 and lower pressure area 102. It is evident that the contour shape and values of pressure depicted in FIG. 10 are in substantial agreement with those in original reservoir model shown in FIG. 9. This is especially notable along the left side of the figures where pressure is higher. This illustrates the accuracy of data mapping in two dimensions by the proposed inventive method for this horizontal plane.

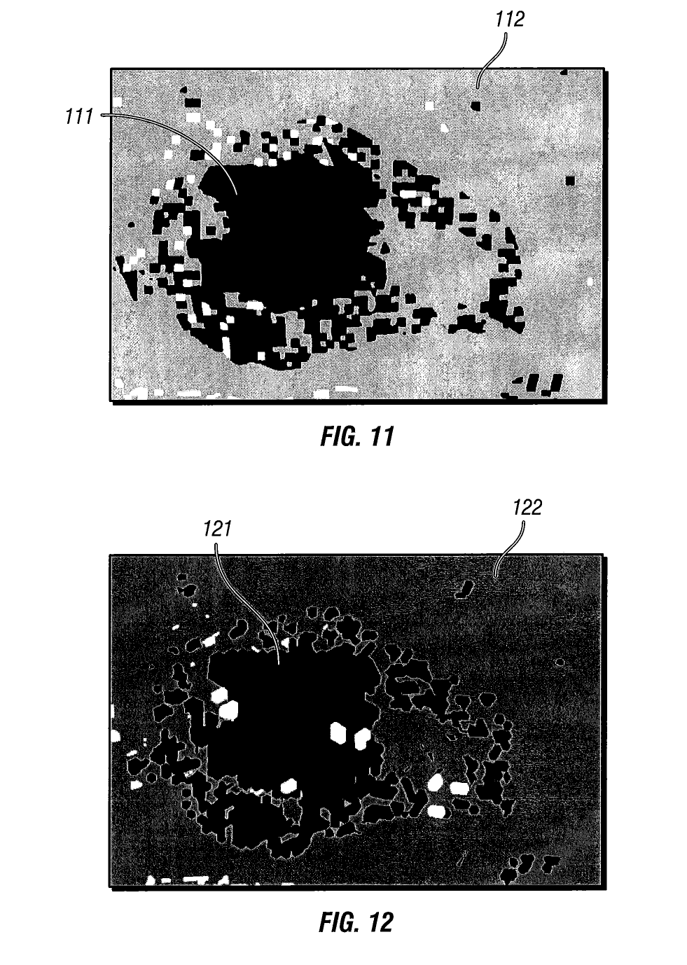

In order to validate the accuracy of data mapping in three dimensions, pressure comparisons at two more different depths are also examined from FIGS. 11 to 14. FIGS. 11 and 12 compare the pressure distribution at a depth 100 above the plane shown in FIGS. 9 and 10 where FIG. 11 shows original pressure data in the reservoir model with higher pressure area 111 and lower pressure area 112 and FIG. 12 demonstrates the mapped pressure data from reservoir model to the geomechanical finite element model with higher pressure area 121 and lower pressure 122. Obviously, pressure solutions between two models at this depth are also in excellent agreement. The shape of pressure contour, especially at head (on the left) and tail (on the right) of the higher pressure area can be captured remarkably in FIG. 12.

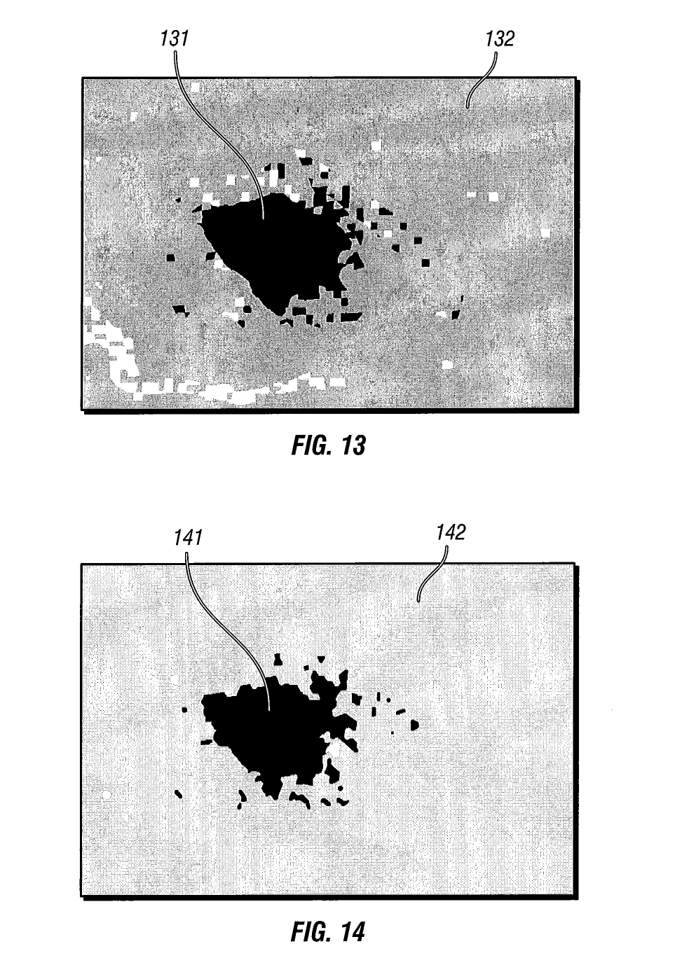

Similarly, FIGS. 13 and 14 depict the contour and values of pressure at a depth of about 80 feet above the FIGS. 11 and 12 depth for the same reservoir where FIG. 13 shows original pressure data in the reservoir model where higher pressure is in area 131 and lower pressure is in the area 132 and FIG. 14 demonstrates the mapped pressure data from reservoir model to the geomechanical finite element model with higher pressure in area 141 and lower pressure in area 142. It is readily observed that the pressure mapping from reservoir model shown in FIG. 13 to geomechanical model shown in FIG. 14 is also performed effectively.

As described above, FIGS. 9 to 14 show pressure values over the three representative depths with the intervals of 100 feet and 80 feet, which encompass the most of reservoir production zone in this reservoir model. Therefore, achievement of excellent pressure mapping results in three dimensions over these depth intervals will allow us to move forward to solve this engineering problem accurately and efficiently using simulation coupling study. It should also be recognized that these drawings are for explanation and that in practice, more granularity is available by using color coded diagrams where multiple levels of pressure or other parameters are used and easily shown.

Thus it can be seen that utilizing the proposed least squares finite element technique and procedure, efficient pressure mapping in three dimensions from corner-point grid in the reservoir simulation model to a finite element tetrahedral grid in a geomechanical simulation model has been successfully created. It allows the coupling of reservoir simulation with geomechanical simulation to estimate the mechanical deformation of reservoirs over production/injection period and its impact on production as a consequence.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for the data mapping from block centered reservoir simulation model to node centered finite element model in geomechanical simulation comprising:
a) identify and locating each numerical integration point of each finite element used in geomechanical model and find the reservoir grid block where the point falls inside;
b) equalizing data values at numerical integration points of geomechanical simulation elements to the block-center data value of their associated reservoir grid blocks found at that previous step; and
c) performing a least squares finite element method for data mapping.

2. The process according to claim 1 wherein the process further creating one or more maps having both geomechanical data and reservoir data.
